(19) United States
(12) Patent Application Publication
(10) Pub. No.: US 2011/0133442 A1
(43) Pub. Date: Jun. 9, 2011

(54) METHOD FOR INCREASING ADHESION BETWEEN A SECURITY ELEMENT AND A FIBROUS SHEET MATERIAL

(76) Inventors: Douglas A. Crane, Dalton, MA (US); Giles D. Prett, Dalton, MA (US)

(21) Appl. No.: 12/997,390

(22) PCT Filed: Jun. 11, 2009
(86) PCT No.: PCT/US2009/003504

§ 371 Date: Feb. 23, 2011

Related U.S. Application Data
(60) Provisional application No. 61/060,906, filed on Jun. 12, 2008.

(51) Int. Cl. B42D 15/10; G09F 3/10; B42D 15/00; D21H 23/24; D21H 21/40; C09J 7/04; A63F 3/06; B32B 7/02; B32B 7/12

(52) U.S. Cl. 283/71; 283/57; 283/58; 283/74; 283/75; 283/81; 162/201; 162/140; 428/343; 428/347; 428/350; 428/335; 428/354; 428/192; 283/85

(57) ABSTRACT

A method for increasing adhesion between a security element (e.g., a security strip or band) and a fibrous sheet material such as paper is provided. Also provided by way of this invention is a security element laminated to one or more activatable adhesive films, a fibrous sheet material having such a laminated structure contained on or within a surface thereof, or at least partially embedded therein, and a document (e.g., a security document such as a banknote) made from such a fibrous sheet material.

### RELATED APPLICATION

This application claims priority from U.S. Provisional Patent Application Ser. No. 61/060,906, filed Jun. 12, 2008, which is fully incorporated herein by reference.

### TECHNICAL FIELD

The present invention generally relates to a method for increasing adhesion between a security element and a fibrous sheet material, and more particularly relates to a security element laminated to one or more activatable adhesive films, a fibrous sheet material having such a laminated structure contained on or within a surface thereof, or at least partially embedded therein, and a document made from such a fibrous sheet material.

### BACKGROUND AND SUMMARY OF THE INVENTION

Security elements in the form of threads, strips or ribbons are used extensively in banknotes and other documents of high value, providing visual and/or mechanical means for verifying the authenticity of these documents. These security elements may be either fully or partially embedded in the banknote or other high value document, or mounted on a surface thereof.

Security threads are typically embedded into paper during manufacture on, for example, cylinder mould and Fourdrinier paper-making machines. It is common practice to coat these security threads with heat seal coatings before introducing the threads into forming paper webs. These coatings, which take the form of solvent-based polymer solutions or aqueous solutions or dispersions, serve to anchor the thread in the paper by melting and acting as an adhesive when exposed to elevated temperatures during the paper-making process. Heat seal coatings are also used to adhere security elements such as holograms and hologram strips to banknote surfaces.

Several disadvantages have been attributed to the use of these heat seal coatings. The temperatures required to plasticize heat seal coatings have been known to adversely impact upon the quality of the paper substrate. Moreover, reheating the adhesive on a surface mounted hologram allows for its removal and transfer to another document.

Radiation-curable adhesives have also been used to anchor security threads and to apply holograms. One such adhesive is described in U.S. Patent Application Publication No. US 2008/0014378 A1 to Hoffmuller et al. The adhesive disclosed in this reference is a coating that includes at least one radiation-crosslinkable component and, in a preferred embodiment, is in the form of a dispersion selected from the group of aliphatic polyurethane dispersions, aromatic polyurethane dispersions, acrylates, anionic acrylate-modified polyurethane dispersions, polyurethane-polyether acrylates and their mixtures. Acrylated polyurethane dispersions are identified as being particularly well suited (see page 2, paragraph [0030]). In a further preferred embodiment, the coating is present as a cationically radiation-curing resin, with epoxide-modified vinyl copolymers being identified as particularly well suited (see page 3, paragraph [0039]). The coating is described as low-melting, but at room temperature substantially tack-free (see page 1, paragraph [0016]).

Unfortunately, the coatings described in this reference require a crosslinking step (and possibly also a pre-crosslinking step) during manufacture of the depicted security paper. Any such additional step(s), which may have to be performed off-line, adversely impacts upon process economics.

It is an object of the present invention to address these disadvantages by providing a novel way to more firmly anchor security elements to fibrous sheet materials.

The present invention therefore provides a method for increasing adhesion between a security element (e.g., a security strip or band) and a fibrous sheet material, the method comprising:
adhering one or more activatable adhesive films to at least one surface of the security element to form a laminated structure;
introducing the laminated structure either (i) onto or into a forming fibrous web at the wet end of a Fourdrinier or twin wire paper machine, or (ii) against a fibrous web forming cylinder in a cylinder paper machine before that portion of the forming cylinder is immersed in pulp or furnish; and after the fibrous web is sufficiently consolidated (i.e., having a moisture level of less than about 5% by weight, based on the total weight of the fibrous web),
activating the one or more adhesive films to firmly bond the security element to the sufficiently consolidated fibrous web.

The present invention also provides a laminated structure comprising a security element adhered to one or more activatable adhesive films, and a fibrous sheet material suitable for use in making multiple-use documents such as banknotes that has one or more such laminated structures contained on or within a surface thereof, or at least partially embedded therein.

In one contemplated embodiment, the fibrous sheet material has one laminated structure in the form of an elongate strip or band recessed in a surface thereof, the security element being fully viewable from this surface. The laminated strip, which comprises a security element adhered to one activatable adhesive film, has a thickness ranging from about 20 to about 100 microns (μ) (preferably, from about 20 to about 50μ) and a width limited only by the width of the fibrous sheet material (preferably, from about 0.5 to about 18 millimeters (mm)). The laminated strip is applied to a surface of a forming fibrous web or sheet material during manufacture while the paper fibers are still mobile. The resulting fibrous sheet material has a substantially uniform cross-web caliper or thickness. Moreover, the area underlying the strip is thinner, less opaque and has a grammage lower than that of the surrounding base sheet.

As evident from the above description, the present invention contemplates the use of very wide strips or bands. Surface recessing these wider strips provides for larger exposed surface areas, which increases the design options and provides an opportunity to more effectively present, for example, optically variable marks or designs. The strip, which is fully viewable and thus more visually apparent, makes it more effective as a public security feature. In addition, the present invention contemplates the use of thicker and thus more robust security elements without a concomitant increase in the thickness of the sheet material in the area containing the security element.

In another contemplated embodiment, the laminated strip or band is partially embedded in the fibrous sheet material and exposed in windows in at least one side of the material. The strip may also be fully embedded in the sheet material, in which case it is preferred to have one activatable adhesive film adhered to each opposing surface of the security element to more firmly anchor the laminated strip in the sheet material. In either embodiment, the strip has a preferred thickness of less than about 50μ, and a preferred width of at least about 0.5 mm (more preferably, from about 1 to about 5 mm, or even up to 6 or 8 mm in width).

The present invention further provides a fibrous sheet material suitable for use in making single-use documents such as lottery tickets that has one or more security elements recessed in (and fully viewable from) a surface thereof, the security element(s) either adhered to one or more activatable adhesive films or coated with an adhesive/binder coating. The security element(s) is applied to a surface of a forming fibrous web or sheet material during manufacture while the paper fibers are still mobile. As noted above, the resulting fibrous sheet material has a substantially uniform cross-web caliper or thickness, and the area underlying the security element(s) is thinner, less opaque and has a grammage lower than that of the surrounding base sheet.

The present invention also provides documents made from the above-described fibrous sheet materials. These documents include security documents such as a banknotes, bonds, checks, travelers checks, identification cards, lottery tickets, passports, postage stamps, and stock certificates, as well as non-security documents such as stationery items and labels.

Other features and advantages of the invention will be apparent to one of ordinary skill from the following detailed description and drawings. Unless otherwise defined, all technical and scientific terms used herein have the same meaning as commonly understood by one of ordinary skill in the art to which this invention belongs. All publications, patent applications, patents and other references mentioned herein are incorporated by reference in their entirety. In case of conflict, the present specification, including definitions, will control. In addition, the materials, methods, and examples are illustrative only and not intended to be limiting.

### BRIEF DESCRIPTION OF THE DRAWINGS

Particular features of the disclosed invention are illustrated by reference to the accompanying drawings in which:

FIG. 1 is an enlarged, cross-sectional, diagrammatic side view of one embodiment of the laminated structure of the present invention;

FIG. 2 is a schematic diagram of a Fourdrinier paper-making machine employing a dandy roll to introduce the inventive laminated structure in the form of a strip or band onto or into a forming fibrous web;

FIG. 3 is a schematic diagram of a paper-making machine made up of two cylinder paper machines interconnected by a pick-up felt, the inventive laminated structure (in the form of a strip or band) contacting a forming cylinder in one cylinder paper machine before that portion of the forming cylinder is immersed in pulp or furnish;

FIG. 4 is a plan view of a front or upper surface of a preferred embodiment of the inventive fibrous sheet material with a surface recessed laminated strip or band, the surface recessed strip being continuously exposed on the front or upper surface of the sheet material and concealed from view on a back or lower surface of the sheet material; and

FIG. 5 is a cross-sectional view of the sheet material shown in FIG. 4.

### BEST MODE FOR CARRYING OUT THE INVENTION

Activatable adhesive films adhered to security strips or bands, upon activation serve to more firmly anchor these strips to a fibrous sheet material. When activated, these films soften and penetrate into the surrounding fibrous sheet material forming a mechanical, as well as a chemical bond to the sheet material. Documents prepared from these fibrous sheet materials demonstrate increased durability.

As described above, the inventive method for increasing adhesion between a security element and a fibrous sheet material comprises:
adhering one or more activatable adhesive films to at least one surface of the security element to form a laminated structure;
introducing the laminated structure either (i) onto or into a forming fibrous web at the wet end of a Fourdrinier or twin wire paper machine, or (ii) against a fibrous web forming cylinder in a cylinder paper machine before that portion of the forming cylinder is immersed in pulp or furnish; and after the fibrous web is sufficiently consolidated,
activating the one or more adhesive films to firmly bond the security element to the sufficiently consolidated fibrous web.

The security element used in the practice of the present invention is not limited. It may display or project information that is humanly perceivable either directly or with the aid of a device and/or embody information that is detectable/readable by machine. The security element may be segmented into regions, with the information being displayed or projected or otherwise contained in some or all of these regions being the same or different.

Suitable security elements may employ one or more of the following security features: demetalized or selectively metalized, magnetic, combined magnetic and metallic, or embossed (e.g., blind embossed) regions or layers, color changing coatings made up of color shift, iridescent, liquid crystal, photochromic and/or thermochromic materials, coatings of luminescent and/or magnetic materials, holographic and/or diffractive security features, and micro-optic security features.

In a preferred embodiment, the security element is a micro-optic structure. Such structures project one or more synthetically magnified optical images, and generally comprise: (a) a light-transmitting polymeric substrate; (b) an arrangement of micro-sized image icons located on or within the polymeric substrate; and (c) an arrangement of microlenses. The icon and microlens arrangements are configured such that when the arrangement of icons is viewed through the arrangement of microlenses, one or more synthetically magnified optical images are projected. These projected images may show a number of different optical effects. Such structures are described in U.S. Pat. No. 7,333,268 to Steenblik et al., U.S. Pat. No. 7,468,842 to Steenblik et al., U.S. Patent Application Publication No. 2008/0037131 to Steenblik et al., International Patent Publication Number WO 2005/106601 A2 to Commander et al., and International Patent Publication Number WO 2007/076952 A2 to Kaule et al. In a more preferred embodiment, a micro-optic structure as described in U.S. Pat. No. 7,333,268 to Steenblik et al. is employed, the structure being formed from a polymeric substrate prepared using one or more essentially colorless polymers selected from the group including, but not limited to, polyester, polyethylene, polyethylene terephthalate, polypropylene, polyvinyl carbonate, polyvinylidene chloride, and combinations thereof.

The security element may include additional security features or devices, coatings, or layers; provided that any such additional security feature or device, coating, or layer does not result in an unacceptable increase in thickness or interfere with the optical effects or visual perception of any magnified or synthetic images produced by the security element. By way of example only, optionally textured layers that incorporate pigments such as titanium dioxide may be used to help hide the security element where embedded in paper and viewed with reflected light.

The thickness of the security element used to make laminated structures for recessing in a surface of a fibrous sheet material ranges from about 15 to about 50μ (preferably, from about 15 to about 30μ), while the thickness of the security element used to make laminated structures for partially or fully embedding in a fibrous sheet material ranges from about 15 to about 45μ (preferably, from about 15 to about 30μ).

Activatable adhesive films suitable for use in the present invention include heat-activated or thermosensitive adhesive films that activate at temperatures ranging from about 100° C. to about 160° C., temperatures typically reached in secondary dryer sections of conventional papermaking machines, as well as water-activated and pressure-activated adhesive films. In a preferred embodiment, the activatable adhesive film is a clear and optically transparent, or white thermosensitive adhesive (TSA) film selected from the group of thermosensitive polyolefin adhesive films and thermosensitive polyurethane adhesive films. These films are substantially tack-free at room temperature.

The thickness of the TSA film used to make laminated structures for recessing in a surface of a fibrous sheet material ranges from about 5 to about 50μ (preferably, from about 5 to about 20μ), while the thickness of the TSA film used to make laminated structures for partially or fully embedding in a fibrous sheet material ranges from about 5 to less than about 35μ (preferably, from about 5 to about 25μ, more preferably, from about 10 to about 20μ).

The ability to use thicker TSA films in laminated structures for surface recessing applications allows for the embedment of, among other things, microcircuitry such as Radio Frequency Identification (RFID) tags in the TSA film.

In practice, a TSA film may be extruded onto a web of the security elements (either during or post manufacture), or a freestanding TSA film may be adhered or laminated to a web of the security elements using conventional lamination techniques prior to slitting the web into individual security elements. Such films may be supplied with or without a paper or polymer (e.g., polyester) carrier film, or may be supplied with a co-extruded, non-adhered polymer film layer.

By way of example, a suitable lamination technique would involve continuously applying a TSA film to a back side of a web of the security elements, exposing the layered structure to temperatures ranging from about 60° C. to about 200° C. (preferably, from about 120° C. to about 180° C.), passing the heated structure through a compression nip (applied nip pressure ranging from about 6.9×10² to about 6.9×10⁵ pascals) for from about 5 milliseconds to about 30 seconds to form a laminated structure having a thickness ranging from about 20 to about 100μ, and if necessary, removing the carrier film or co-extruded film layer from the laminated structure to expose the TSA film.

Once the laminated structure is prepared, it may be cut or slit into any shape or form including, but not limited to, strips or bands, threads, planchettes, or patches. The strips or bands and threads may have constant or variable edge profiles. Preferably, the laminated structure is slit to provide either (i) wide strips or bands (preferably, from about 0.5 to about 18 mm in width) for recessing in a surface of a fibrous sheet material, or (ii) narrow threads (preferably, at least about 0.5 mm in width, more preferably, from about 1 to about 5 mm, or even up to 6 or 8 mm in width) for partially or fully embedding in a fibrous sheet material. The strips or threads would then be wound onto bobbins or spools.

Referring now to FIG. 1 of the drawings, a preferred embodiment of the laminated structure of the present invention in the form of a strip or band is shown generally at 10. The laminated strip 10 includes a security element 12 and an activatable adhesive film 14.

Fibrous sheet materials suitable for use in the present invention are paper or paper-like sheet materials. These sheet materials, which are single or multi-ply sheet materials, may be made from a variety of fibers such as abaca, cotton, linen, wood pulp, and blends thereof. As is well known to those skilled in the art, cotton and cotton/linen or cotton/synthetic fiber blends are preferred for banknotes and for non-security documents such as stationery items, while wood pulp is commonly used in non-banknote security documents and non-security documents such as labels.

As alluded to above, the laminated strip 10 may be at least partially incorporated in fibrous sheet materials during manufacture by techniques commonly employed in the papermaking industry. The strip 10 may also be mounted on or recessed in a surface of a fibrous sheet material either during or post manufacture.

In a preferred embodiment, the laminated strip 10 is recessed in a surface of a forming fibrous web or sheet material during manufacture.

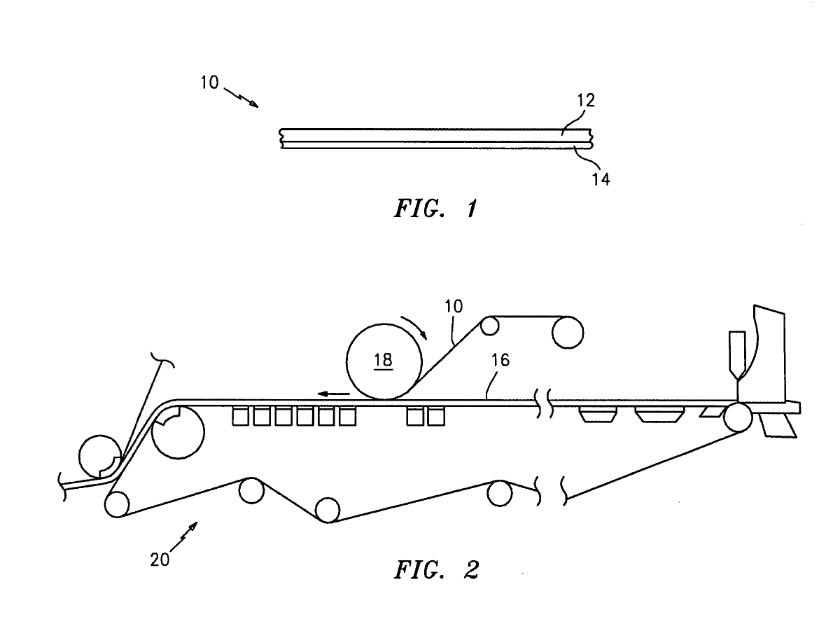

Referring now to FIG. 2, in a Fourdrinier process for making a single-ply embodiment of the fibrous sheet material of the present invention, the laminated strip 10 (oriented such that the security element 12 is an uppermost layer) is pushed into a surface of a partially consolidated forming fibrous web 16 (i.e., a fibrous slurry containing from about 0.5 to about 5% by weight stock and from about 99.5 to about 95% by weight water) by, for example, a dandy roll 18 at the wet end 20 of the paper-making machine. The fibers in the forming web 16 are mobile at this stage in the paper-making process. As water continues to drain from web 16, the fibers form around the strip 10 holding it in place on a front or upper surface of web 16. Upon leaving the wet-end 20, the web 16 is passed through the press, main and secondary dryer and calender sections of the paper-making machine. While in the secondary dryer section of the paper-making machine, the web 16 is exposed to temperatures and/or pressures sufficient to soften the adhesive film, causing or forcing it to penetrate into the web. The laminated strip 10 in the resulting fibrous sheet material is firmly bonded to the sheet material, with security element 12 continuously exposed on a front or upper surface of the sheet material, while concealed from view on a back or lower surface of the sheet material. As previously noted, the fibrous sheet material has a substantially uniform cross-web caliper or thickness. Moreover, the area underlying strip 10 is thinner, less opaque and has a grammage lower than that of the surrounding base sheet.

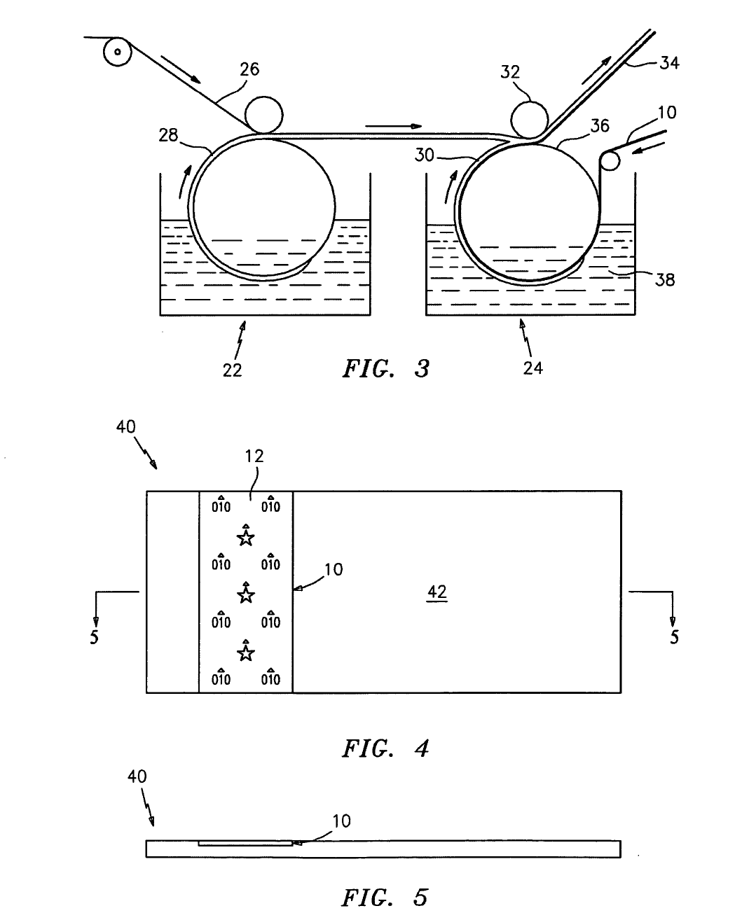

A cylinder mould process for making a two-ply embodiment of the fibrous sheet material of the present invention is shown in FIG. 3. In this process, which employs two cylinder paper machines 22, 24, interconnected by pick-up felt 26, two paper webs 28, 30, are formed simultaneously, squeezed together in the area of roll 32, and then fed together to the press, dryer and calender sections of the paper-making machine. The resulting fibrous sheet material has the same physical characteristics as those noted above for sheet materials made using a Fourdrinier process. As will be readily appreciated by those skilled in the art, while FIG. 3 shows cylinder paper machines of the wet vat type, cylinder paper machines of the dry vat type may also be used to make the fibrous sheet material of the present invention.

Two-ply paper web 34, formed by the cylinder paper machine shown in FIG. 3, has laminated strip 10 recessed in a surface thereof, with security element 12 fully viewable from this surface. The laminated strip 10 is integrated into paper web 30 by contacting the strip with forming cylinder 36 in cylinder paper machine 24 before that portion of cylinder 36 is immersed in pulp or furnish 38. As fiber deposition and thus formation of paper takes place through cylinder 36, the fibers form around the strip 10 holding it in place on a front or upper surface of web 30. Paper web 28, which is formed by cylinder paper machine 22, is homogeneous and serves to hide any irregularities in paper formation on a back or lower surface of paper web 30 that may have been caused by the presence of strip 10.

As will be readily appreciated by those skilled in the art, the dandy roll or forming cylinder may be provided with raised and/or recessed areas on its surface, which may partially overlap or border the area contacted by strip 10 during manufacture. For example, in one embodiment contemplated by the present invention, the dandy roll or forming cylinder surface is patterned on either side of the area contacted by strip 10, resulting in a fibrous sheet material which has a pattern of opaque and translucent marks on either side of the surface recessed strip 10.

Referring now to FIG. 4, a preferred embodiment of the fibrous sheet material of the present invention with a surface recessed strip 10, is shown generally at 40. The security element 12 of surface recessed strip 10 is continuously exposed on a front or upper surface 42 of sheet material 40 and either concealed from view on a back or lower surface of the sheet material or exposed through apertures or windows. These so-called “clear windows” allow the strip 10 to be viewed in transmitted light absent the light scattering effects of background paper fibers.

As best shown in FIG. 5, which is a cross-sectional view of the fibrous sheet material shown in FIG. 4, sheet material 40 has a substantially uniform cross-web caliper or thickness.

Fibrous sheet material 40 with surface recessed strip 10 is particularly suitable for use in making multiple-use documents such as banknotes. For fibrous sheet materials with surface recessed security elements that are used to make single-use documents such as lottery tickets, however, the durability requirements are less stringent and adhesive/binder coatings may be used instead of an activatable adhesive film layer. For this embodiment, security element 12, having a preferred width ranging from about 0.5 to about 18 mm, is coated with an adhesive/binder coating and introduced, as described above, to a forming fibrous web while the fibers are still mobile.

Preferred adhesive/binder coatings are water-, heat- and/or pressure-activating adhesives that activate in the secondary dryer section of the papermaking machine, where temperatures reach between 100° C. and 160° C. These coatings may be applied in the form of solvent-based polymer solutions or aqueous solutions or dispersions. Suitable dispersions are selected from the group of acrylic resin dispersions, epoxy resin dispersions, natural latex dispersions, polyurethane resin dispersions, polyvinyl acetate resin dispersions, polyvinyl alcohol resin dispersions, urea formaldehyde resin dispersions, vinyl acetate resin dispersions, ethylene vinyl acetate resin dispersions, ethylene vinyl alcohol resin dispersions, polyester resin dispersions, and mixtures thereof.

While various embodiments of the present invention have been described above, it should be understood that they have been presented by way of example only, and not limitation. Thus, the breadth and scope of the present invention should not be limited by any of the exemplary embodiments.

What is claimed is:

1. A method for increasing adhesion between a security element and a fibrous sheet material, the method comprising:
extruding or laminating one or more activatable adhesive films onto or to at least one surface of the security element to form a laminated structure, wherein the one or more activatable adhesive films are substantially tack-free at room temperature;
introducing the laminated structure either (i) onto or into a forming fibrous web at the wet end of a Fourdrinier or twin wire paper machine, or (ii) against a fibrous web forming cylinder in a cylinder paper machine before that portion of the forming cylinder is immersed in pulp or furnish; and after the fibrous web is sufficiently consolidated,
activating the one or more adhesive films to firmly bond the security element to the sufficiently consolidated fibrous web.

2. The method of claim 1, wherein the security element comprises one or more security features selected from the group of demetalized or selectively metalized regions or layers, magnetic regions or layers, combined magnetic and metallic regions or layers, embossed regions or layers, color changing coatings made up of one or more of color shift, iridescent, liquid crystal, photochromic, and thermochromic materials, luminescent coatings, magnetic coatings, combined luminescent and magnetic coatings, holographic security features, diffractive security features, combined holographic and diffractive security features, and micro-optic security features.

3. The method of claim 2, wherein the security element is a micro-optic structure.

4. The method of claim 1, wherein the one or more activatable adhesive films are selected from the group of heat-activated or thermosensitive, water-activated and pressure-activated adhesive films.

5. The method of claim 4, wherein the one or more activatable adhesive films are clear and optically transparent, or white thermosensitive adhesive films selected from the group of thermosensitive polyolefin adhesive films and thermosensitive polyurethane adhesive films.

6. The method of claim 4, wherein the one or more activatable adhesive films are heat-activated or thermosensitive adhesive films that are activated at temperatures ranging from about 100° C. to about 160° C.

7. The method of claim 1, wherein the one or more activatable adhesive films are activated when the moisture level of the fibrous web is less than about 5% by weight, based on the total weight of the fibrous web.

8. A laminated structure comprising one or more activatable adhesive films extruded onto or laminated to a security element, wherein the one or more activatable adhesive films are substantially tack-free at room temperature.

9. The laminated structure of claim 8, wherein the one or more activatable adhesive films are selected from the group of heat-activated or thermosensitive, water-activated and pressure-activated adhesive films.

10. The laminated structure of claim 9, wherein the one or more activatable adhesive films are clear and optically transparent, or white thermosensitive adhesive films selected from the group of thermosensitive polyolefin adhesive films and thermosensitive polyurethane adhesive films.

11. The laminated structure of claim 8, wherein the security element has a thickness ranging from about 15 to about 50 microns.

12. The laminated structure of claim 8, wherein the security element has a thickness ranging from about 15 to about 45 microns.

13. The laminated structure of claim 8, wherein the one or more activatable adhesive films have a thickness ranging from about 5 to about 50 microns.

14. The laminated structure of claim 13, wherein microcircuitry is embedded in the one or more activatable adhesive films.

15. The laminated structure of claim 8, wherein the one or more activatable adhesive films have a thickness ranging from about 5 to about 35 microns.

16. The laminated structure of claim 8, wherein the laminated structure is in the form of an elongate strip or band that comprises a security element adhered to one activatable adhesive film.

17. The laminated structure of claim 8, wherein the laminated structure is in the form of an elongate strip or band that comprises a security element having opposing surfaces, and one activatable adhesive film adhered to each opposing surface of the security element.

18. A fibrous sheet material suitable for use in making multiple-use documents such as banknotes, which has a substantially uniform cross-web caliper or thickness, and which comprises: a fibrous web; and one or more laminated structures, the one or more laminated structures being made up of one or more activatable adhesive films extruded onto or laminated to a security element, wherein the one or more activatable adhesive films are substantially tack-free at room temperature, and wherein the one or more laminated structures are contained on or within a surface of the fibrous web, or at least partially embedded therein.

19. The fibrous sheet material of claim 18, which has one laminated structure in the form of an elongate strip or band recessed in a front or upper surface of the fibrous web, the elongate strip or band being fully viewable from this surface.

20. The fibrous sheet material of claim 19, wherein the surface recessed strip is concealed from view on a back or lower surface of the fibrous web.

21. The fibrous sheet material of claim 19, wherein the surface recessed strip is exposed through apertures or windows in a back or lower surface of the fibrous web.

22. The fibrous sheet material of claim 19, wherein the laminated structure has a thickness ranging from about 20 to about 100 microns.

23. The fibrous sheet material of claim 22, wherein the laminated structure has a thickness ranging from about 20 to about 50 microns, and a width ranging from about 0.5 to about 18 millimeters.

24. The fibrous sheet material of claim 18, which has one laminated structure in the form of an elongate strip or band that is either partially embedded in the fibrous web and exposed in windows in at least one surface thereof, or fully embedded in the fibrous web.

25. The fibrous sheet material of claim 24, wherein the laminated structure is fully embedded in the fibrous web and has one activatable adhesive film adhered to each opposing surface of the security element.

26. The fibrous sheet material of claim 24, wherein the laminated structure has a thickness ranging from about 20 to about 80 microns.

27. The fibrous sheet material of claim 26, wherein the laminated structure has a thickness of less than about 50 microns and a width of at least about 0.5 millimeters.

28. A fibrous sheet material suitable for use in making single-use documents such as lottery tickets, which has a substantially uniform cross-web caliper or thickness, and which comprises: a fibrous web; and one or more coated security elements contained on or within a surface of the fibrous web, or at least partially embedded therein, wherein the one or more coated security elements are coated with an adhesive/binder coating in the form of a dispersion selected from the group of acrylic resin dispersions, epoxy resin dispersions, natural latex dispersions, polyurethane resin dispersions, polyvinyl acetate resin dispersions, polyvinyl alcohol resin dispersions, urea formaldehyde resin dispersions, vinyl acetate resin dispersions, ethylene vinyl acetate resin dispersions, ethylene vinyl alcohol resin dispersions, polyester resin dispersions, and mixtures thereof.

29. A document made from the fibrous sheet material of claim 18.

30. A document made from the fibrous sheet material of claim 28.

31. The document of claim 29, which is a security document selected from the group of banknotes, bonds, checks, travelers checks, identification cards, lottery tickets, passports, postage stamps, and stock certificates.

32. The document of claim 30, which is a security document selected from the group of checks, travelers checks, lottery tickets, and postage stamps.

33. The document of claim 29, which is a non-security document selected from the group of stationery items and labels.

34. The document of claim 30, which is a non-security document selected from the group of stationery items and labels.

35. The laminated structure of claim 16, wherein the elongate strip or band has a variable edge profile.

36. The laminated structure of claim 17, wherein the elongate strip or band has a variable edge profile.

37. The fibrous sheet material of claim 19, which has a portion of opaque and translucent marks on either side of the surface recessed strip or band.
